(19) United States
(12) Patent Application Publication
(10) Pub. No.: US 2006/0291660 A1
(43) Pub. Date: Dec. 28, 2006

(54) SIM UICC based broadcast protection

(75) Inventors: Christian Gehrmann, Lund (SE); Rolf Blom, Jarfalla (SE)

Correspondence Address: ERICSSON INC., 6300 LEGACY DRIVE, M/S EVR C11, PLANO, TX, 75024, US

(73) Assignee: Telefonaktiebolaget LM Ericsson (publ), Stockholm (SE)

(21) Appl. No.: 11/275,272

(22) Filed: Dec. 21, 2005

Related U.S. Application Data
(60) Provisional application No. 60/693,195, filed on Jun. 23, 2005.

(51) Int. Cl. H04L 9/00

(52) U.S. Cl. 380/277

(57) ABSTRACT

A method is described herein for protecting multicast/broadcast traffic (e.g., mobile TV, multimedia) which is transmitted from a broadcast service provider via a mobile operator to one or more mobile devices. To protect the multicast/broadcast traffic, the method utilizes a broadcast key distribution and encryption architecture that is based in part on the existing GSM/UMTS authentication standards.

### CLAIMING BENEFIT OF PRIOR FILED PROVISIONAL APPLICATION

This application claims the benefit of U.S. Provisional Application Ser. No. 60/693,195 filed on Jun. 23, 2005, which is incorporated by reference herein.

### TECHNICAL FIELD

The present invention relates in general to a method for protecting multicast/broadcast traffic (e.g., mobile TV, multimedia) which is transmitted from a broadcast service provider to one or more user equipments (e.g., mobile devices).

### BACKGROUND

The following abbreviations are herewith defined, at least some of which are referred to in the ensuing description of the prior art and the present invention.
3GPP Third Generation Partnership
AKA Authentication and Key Agreement
AuC Authentication Centre (GSM/UMTS)
AV Authentication Vector
DVB Digital Video Broadcasting
GAA Generic Authentication Architecture
GSM Global System for Mobile Communications
GBA Generic Bootstrapping Architecture
GPRS General Packet Radio Service
HLR Home Location Register
HSS Hughes Software Systems
IMSI International Mobile Subscriber Identity
MAC Message Authentication Code
MBMS Multimedia Broadcast/Multicast Service
MMS Multimedia Messaging Service
SIM Subscriber Identity Module
SMS Short Messaging Service
UE User Equipment
UICC Universal Integrated Circuit Card
UIM User Identity Module
UMTS Universal Mobile Telecommunications System

Broadcast service providers want to securely transmit their content (e.g., mobile TV, multimedia) to a given set of authorized mobile devices. Because, the broadcast service providers do not want unauthorized mobile devices to be able to receive and unlawfully access their content. To prevent the unauthorized use of their content, the broadcast service providers in the past have employed a number of rights protection mechanisms. One such mechanism is the 3GPP MBMS standard, which requires the use of a UMTS UICC (USIM smart card)(associated with the mobile device) to derive keys that are used to decrypt the encrypted content so a user can legally access the content that is received by their mobile device. A detailed discussion about the 3GPP MBMS standard is provided in the following documents:
3GPP TS 33.246: “Security of Multimedia/Multicast Service (release 6)”, v6.2.0 (March 2005).
3GPP TS 22.246; “Multimedia Broadcast/Multicast Service, Stage 1”.
   The contents of these documents are incorporated by reference herein.

Unfortunately, the 3GPP MBMS standard has several limitations/shortcomings as indicated below:
(1) The MBMS key management system is complex and is constructed as a combination of two key management protocols, GBA and MIKEY:
   3GPP TS 33.220: “Generic Authentication Architecture (GAA); Generic Bootstrapping Architecture”.
   IETF RFC 3830 “MIKEY: Multimedia Internet KEYing”.
(2) The broadcast keys are encrypted with a MBMS broadcast “group key” that is distributed to a large number of mobile devices. Because, the “group key” is distributed to a large number of mobile devices and it must be kept secret this introduces an increased security risk.
(3) The “group key” can either be protected in the UICC or in the mobile device.

Protection in the mobile device requires that the mobile device supports the 3GPP GBA standard. Furthermore, protection in the mobile device requires that the mobile device supports and implements new security requirements. However, these security requirements cannot be fulfilled by all mobile devices. The UICC based implementation option does not have this problem, but on the other hand it does require a further upgrade of the UICC.
(4) The solution only works with the 3GPP UICC (USIM smart cards) and not with the old GSM SIM cards.

As can be seen, the 3GPP MBMS standard has several limitations/shortcomings which can make it difficult for the broadcast service provider to effectively prevent people with unauthorized mobile devices/smart cards from receiving and accessing their content. This problem and other problems are addressed by the present invention.

### SUMMARY

The present invention is related to a method for protecting multicast/broadcast traffic (e.g., mobile TV, multimedia) which is transmitted from a broadcast service provider via a mobile operator to one or more mobile devices/smart cards. In one embodiment, the broadcast service provider performs the following functions: (1) encrypt broadcast/multicast information based on a broadcast key (KB) to produce encrypted broadcast/multicast information; (2) generate a random nonce value (N) corresponding to the broadcast key (KB); (3) transmit the broadcast key (KB), a session identification (ID) and the random nonce value (N) to the mobile operator; and (4) transmit the encrypted broadcast/multicast information, the session identification (ID) and the random nonce value (N) to the mobile device/smart card. The mobile operator performs the following functions: (1) derive authentication vector containing a random challenge value (RAND) and if present an authentication token (AUTN); (2) encrypt the broadcast key (KB) with a shared key KE (the same as or derived from the GSM/UMTS encryption key and/or integrity key) to produce an encrypted broadcast key (KB′); (3) encrypt the (RAND) with the random nonce value (N) to produce an encrypted random challenge value (RAND′); and (4) transmit the encrypted broadcast key (KB′), the encrypted random challenge value (RAND′), the session identification (ID) and if present the AUTN to the mobile device/smart card. The mobile device/smart card performs the following functions: (1) store the encrypted broadcast key (KB′), the encrypted random challenge value (RAND′), the session identification (ID) and if provided the authentication token (AUTN) that are received from the mobile operator; (2) store the encrypted broadcast/multicast information, the session identification (ID) and the random nonce value (N) that are received from the broadcast service provider; (3) decrypt the encrypted random challenge value (RAND′) using the random nonce value (N) to obtain the random challenge value (RAND); (4) determine the shared key (KE) using the random challenge value (RAND) and if provided the authentication token (AUTN); (5) decrypt the encrypted broadcast key (KB′) using the shared key (KE) to obtain the broadcast key (KB); and (6) decrypt the encrypted broadcast/multicast information using the broadcast key (KB).

### BRIEF DESCRIPTION OF THE DRAWINGS

A more complete understanding of the present invention may be had by reference to the following detailed description when taken in conjunction with the accompanying drawings wherein:

FIG. 1 is a block diagram illustrating the basic components of a multicast/broadcast network which includes a broadcast service provider, a mobile operator and a mobile device/smart card in accordance with the present invention;

FIG. 2 is a flow diagram, that is used to help describe the basic steps of a method for protecting multicast/broadcast traffic (e.g., mobile TV, multimedia) which is transmitted from the broadcast service provider to the mobile device/smart card in accordance with the present invention;

FIG. 3 is a flow diagram that depicts the standard GSM authentication/key generation process which is modified and used by the method shown in FIG. 2 in accordance with the present invention; and

FIG. 4 is a flow diagram that depicts the standard UMTS. authentication/key generation process which is modified and used by the method shown in FIG. 2 in accordance with the present invention.

### DETAILED DESCRIPTION

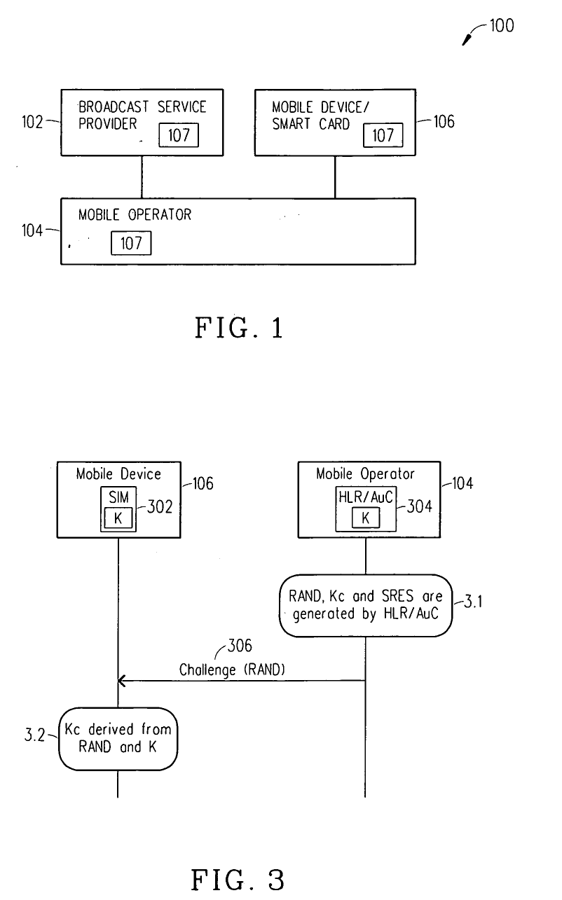

Referring to FIG. 1, there is a block diagram illustrating an example of a multicast/broadcast network 100 embodying the present solution which comprises a broadcast service provider 102, a mobile operator 104 and a mobile device 106 (which includes a smart card). Each of the broadcast service provider 102, the mobile operator 104 and the mobile device/smart card 106 has a processor/logic/computer 107 incorporated therein that can perform various actions in accordance with the present solution by using specialized circuits or circuitry (e.g., discrete logic gates interconnected to perform a specialized function), program instructions, or a combination of both.

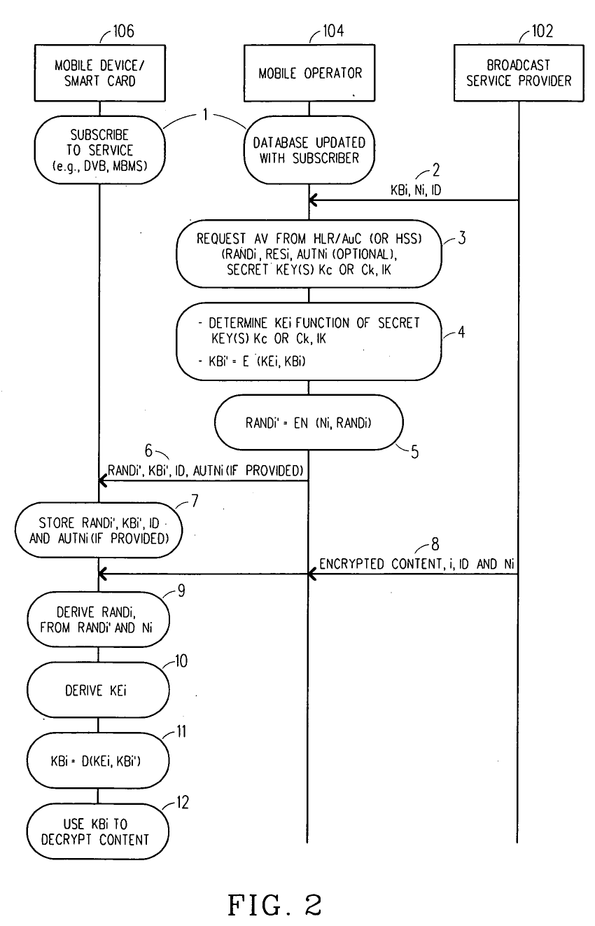

A method is described below for protecting multicast/broadcast traffic (e.g., mobile TV, multimedia) which is transmitted from the broadcast service provider 102 to the mobile device/smart card 106 (only one shown). The broadcast service provider 102 would like to protect their multicast/broadcast traffic to prevent unauthorized users from using unauthorized mobile devices/smart cards to unlawfully receive and access their multicast/broadcast traffic. A step-by-step description of a method is provided next with respect to FIG. 2.

Referring to FIG. 2, there is a signal flow diagram illustrating a step-by-step description of the broadcast protection and key derivation functions associated with one method of the present invention. The steps are as follows:

(1) A mobile user would like to use their mobile device 106 to download broadcasted information such as mobile TV or multimedia. Examples of two services that can be used to broadcast or multicast this information are described in the 3GPP MBMS standard and the DVB standard. Details about these standards can be found in the following documents:
3GPP TS 22.146; “Multimedia Broadcast/Multicast Service, Stage 1”.
ETSI EN 300 744 “Digital Video Broadcasting (DVB); Framing Structure, Channel Coding and Modulation for Digital Terrestrial Television”.

The mobile user needs to subscribe to a service like one of these in order to get access to the broadcasted information. A broadcast service-registering item in the mobile operator's subscription database (e.g., HLR/AuC) can constitute evidence of the mobile user's subscription. For instance, the mobile operator's subscription database (e.g., HLR/AuC) can contain the IMSI number and telephone number of the mobile device 106 in addition to other credentials to constitute evidence of the mobile user's subscription. Assume that each broadcasting/multicast service is identified by a certain service identifier value. And, assume that this value is denoted by ID which is also stored in the subscription database (e.g., HLR/AuC).

(2) The broadcast service provider 102 protects the broadcast/multicast information by generating a batch of keys, n keys. Denote the keys by KBᵢ, 0<=i<=n-1. Each key, KBᵢ, is used to encrypt one particular part of the broadcasted information. Furthermore; the broadcast service provider 102 generates a corresponding batch of random nonce values, Nᵢ, 0<=i<=n-1. Next, the broadcast service provider 102 gives the set of keys KBᵢ and random nonce values Nᵢ to the mobile operator 104 together with the ID of the service for which the keys KBᵢ and nonce values Nᵢ shall be used. In an alternative embodiment, the content does not need to be directly encrypted with the batch keys KBᵢ but instead the KBᵢ can be used as “master keys” to derive a new set of keys KBnewᵢ that can then be used to encrypt the content.

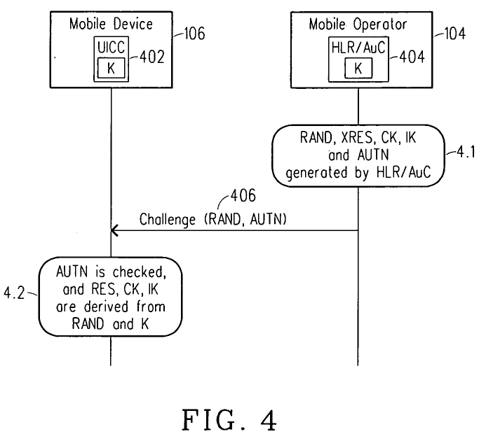

(3) The mobile operator 104 finds out which of its subscribers have subscribed to the broadcast service using the received service ID. And, for each of these subscribers, the mobile operator 104 requests the appropriate number of authentication vectors from its HLR/AuC (or HSS)(see FIGS. 3 and 4). In response to receiving the request, the HLR/AuC generates the authentication vectors including a batch of random challenges RAND and authentication tokens (AUTNs)(UMTS only). The random challenges RAND for one particular mobile device 106 can be denoted by, RANDᵢ, 0<=i<=n-1, and the corresponding authentication tokens (UMTS only) by, AUTNᵢ, 0<=i<=n-1. This can be done by using the existing GSM/UMTS authentication standards (see discussion below with respect to FIGS. 3 and 4).

(4) The mobile operator 104 uses the random values RANDᵢ, the secret key(s) Kc or Ck, Ik and the expected response RES in each authentication vector to calculate a corresponding encryption key, KEᵢ, 0<=i<=n-1. These encryption keys KEᵢ or a function thereof are then used to encrypt the batch of broadcast keys as KBᵢ′=E(KEᵢ,KBᵢ), where E denotes a suitable encryption function.

(5) The mobile operator 104 then replaces each of the original random challenges RANDᵢ with another value that is denoted by RANDᵢ′ where RANDᵢ′=EN(Nᵢ,RANDᵢ) and EN is some suitable encryption algorithm and the nonce value Nᵢ is used as the key. One option is to let RANDᵢ′=Nᵢ ⊕RANDᵢ, where ⊕ denotes a bitwise XOR operation.

(6) The mobile operator 104 sends the batch of random encrypted challenges, RAND₀′, RANDᵢ′, . . . , RANDₙ₋₁′, (together with the corresponding authentication tokens AUTNᵢ in the UTMS case), the batch of encrypted broadcast keys, KB₀, KBᵢ′, . . . , KBₙ₋₁′, and the service ID to the mobile device 106. Examples of suitable communication channels that can be used to send this information include SMS, MMS, or GPRS or any other appropriate data channel.

(7) The mobile device 106 receives the batch of encrypted random values RANDᵢ′, the authentication tokens AUTNᵢ (in the UMTS case), the encrypted broadcast keys KBᵢ′ and the service ID and stores all of these values in non-volatile storage.

(8) The broadcast service provider 102 sends the encrypted broadcast/multicast information. The broadcasted content is sent in n different sequences, each sequence is encrypted with a separate encryption key, KBᵢ. Before the encrypted sequence is sent over a channel (more specifically any data channel, e.g., SMS, MMS or GPRS data channel), the broadcast service provider 102 sends the nonce value Nᵢ, and the number of the sequence, i, together with the service ID. To make sure that no mobile device 106 misses this important information, it might be retransmitted several times or it might even be included in each frame of the broadcasted content.

(9) The mobile device 106 receives the broadcast/multicast information and fetches the session ID, the nonce, Nᵢ, and sequence value, i, from the broadcasted signal. If the session ID corresponds to the value stored at step 7, then the mobile device 106 uses the received nonce, Nᵢ, to derive the original random challenge RAND. For example, if the XOR operation was used by the mobile operator 104 in step 5 to encrypt the random challenges RAND, then the decrypted random value is obtained as RANDᵢ=RANDᵢ′⊕ Nᵢ.

(10) The mobile device 106 sends the RANDᵢ (together with the corresponding AUTNᵢ value in the UMTS case) to the smart card (SIM card or UICC) and obtains a key or set of keys that are used to derive the encryption key KEᵢ. In particular, the key KE is either formed directly from secret key(s) Kc or Ck, Ik and RES or it is a function thereof.

(11) The mobile device 106 uses the encryption key KEᵢ obtained in step 10 to decrypt the stored broadcast key, KBᵢ=D(KEᵢ; KBᵢ′), where D is the decryption function corresponding to the encryption function E which was used by the mobile operator 104 in step 4.

(12) The mobile device 106 uses the broadcast keys, KBᵢ, to decrypt the received broadcast/multicast information.

As indicated in steps 4 and 10, the mobile operator 104 gets the AV and the secret keys and derives the KE. And, the mobile device 106 gets the RAND and derives KE. A brief discussion about how this is done is provided next with respect to FIGS. 3 and 4.

First, a discussion is provided about how the mobile operator 104 and the mobile device/smart card 106 when configured in accordance with GSM can each use part of the existing GSM authentication standard to derive the shared encryption key KE. As shown in FIG. 3, the GSM authentication process is based on a 128-bit secret key, K, which is stored in a SIM smart card 302. The mobile operator 104 stores the secret key K in the HLR/AuC 304. The HLR/AuC 304 uses the K to derive the authentication vectors which in this case are known as triplets (see box 3.1 and step 3 in FIG. 2). Each triplet is composed of:
RAND: 128-bit random number, to be used as a challenge.
Kc: 64-bit long key, intended to be used as an encryption key over the air * interface.
SRES: 32-bit response to the challenge.

If the existing GSM authentication standard was used at this point then the mobile operator 104 would challenge the mobile device 106 with an unencrypted RAND (as shown in FIG. 3). However, in the present solution, the mobile operator 104 sends the mobile device 106 an encrypted RANDᵢ′ (see step 6 in FIG. 2). Also, in the present solution, the mobile device 106 uses the random nonce Nᵢ to decrypt RANDᵢ′ and generate RANDᵢ (see step 9 in FIG. 2). Then, in the present solution, the SIM card 302 generates the Kc using RANDᵢ and the internally stored K (see step 10 in FIG. 3). In contrast, in the existing GSM authentication standard, the SIM card 302 generates the Kc using the RAND and the internally stored K (see box 3.2 in FIG. 3). In either case, the mobile operator 104 and the mobile device 106 at this point each have the shared secret Kc. And, in one embodiment of the present solution, the encryption key KE=Kc. Alternatively, one could set KE=Kc|SRES (where| denotes concatenation) in order to have 96 bits of protection. As can be seen, KE can be the same as Kc or derived from Kc (GSM encryption key). For a more detailed discussion about the standard GSM authentication process, reference is made to the following document:
3GPP TS 43.020 v.5.0.0 “Security Related Network Functions (Release 5)”, July 2002.
   The contents of this document are incorporated by reference herein.

Second, a discussion is provided about how the mobile operator 104 and the mobile device/smart card 106 when configured in accordance with UMTS can each use part of the existing UMTS authentication standard to derive a shared encryption key KE (discussed below as shared secret CK|K). As shown in FIG. 4, the UMTS authentication process is similar to the GSM authentication process, but the UMTS authentication process has some additional security mechanisms:
The mobile device 106 is assured that the mobile operator 104 is the claimed one.
An additional key is derived and used to ensure integrity protection over the air interface.
Longer keys and response values are used for increased security.

As in the GSM authentication process, there is a 128-bit secret key, K, which is stored in a USIM smart card 402. The mobile operator 104 stores the secret key K in the HLR/AuC 404. The HLR/AuC 404 uses the secret key K to derive authentication vectors known as quintets (see box 4.1 and step 3 in FIG. 2). Each quintet is composed of:
RAND: 128-bit random number, to be used as a challenge.
XRES: 32-bit to 128-bit response to the challenge.
CK: 128-bit long key, to be used as a cipher key over the air interface.
IK: 128-bit long key, to be used as an integrity key over the air interface.
AUTN: 128-bit value, used for network authentication.

If the existing UMTS authentication standard was used at this point, then the mobile operator 104 would simply challenge the mobile device 106 with an unencrypted RAND and AUTN (see signal 406 in FIG. 4). However, in the present solution, the mobile operator 104 sends the mobile device 106 an encrypted RANDᵢ′ and AUTNᵢ (see step 6 in FIG. 2). Also, in the present solution, the mobile device 106 uses the random nonce Nᵢ to decrypt RANDᵢ′ and generate RANDᵢ (see step 9 in FIG. 2). Then, in the present solution, the USIM smart card 402 checks that the AUTN is correct, and then it generates RES, CK and IK, using the decrypted RANDᵢ and the internally stored K (see step 10 in FIG. 2). In contrast, in the existing UMTS authentication standard, the USIM smart card 402 checks that the AUTN is correct, and then it generates RES, CK and IK, using the RAND and the internally stored K (see box 4.2 in FIG. 4). In either case, the mobile operator 104 and the mobile device 106 at this point each have shared secrets CK and IK. And, in one embodiment of the present solution, KE=CK|IK, where| denotes a concatenation of the two key values. For a more detailed discussion about the standard UMTS authentication process, reference is made to the following document:
3GPP TS 33.102: “3G Security Architecture (release 6)” September: 2003.
   The contents of this document are incorporated by reference herein.

From the foregoing, it can be readily appreciated by those skilled in the art that the present solution utilizes two levels of encryption to help protect multicast/broadcast traffic. The first protection level involves the mobile operator 104 deriving a shared key KE (related to the GSM/UMTS encryption key and/or integrity key (UMTS case)) and using the shared key KE to encrypt the broadcast key KB received from the broadcast service provider 102 (see steps 2-4 in FIG. 2). And, the second protection level involves the application of yet another encryption step that is implemented by the mobile operator 104 in which the random challenge number (RAND) is encrypted using a random nonce value (N) that was provided to it along with the broadcast key (KB) by the broadcast service provider 102 (see steps 1 and 5 in FIG. 2). After these encryption steps, the mobile operator 104 transmits the encrypted random challenge number RAND′ along with the encrypted broadcast key KB′ to the mobile device 106 (see step 6 in FIG. 2). It is important for the mobile operator 104 to transmit the encrypted random challenge number RAND′ to the mobile device 106, since the mobile device 106 will not be able to derive the content encryption key KB until after it receives the first part of the encrypted multicast/broadcast information and the random nonce value N from the broadcast service provider 102 (see step 9 in FIG. 2). In other words, the mobile device 106 needs the random nonce value N so it can decrypt the encrypted random challenge RAND′ and derive the original random challenge RAND. Once, the mobile device 106 has the original random challenge RAND then it can derive (through the SIM smart card/UICC) the shared key KE (related to the GSM/UMTS encryption key and/or integrity key (UMTS case)) (see step 10 in FIG. 2 and FIGS. 3-4). Then, the mobile device 106 can use the shared key KE to decrypt the encrypted broadcast key KB′ it received from the mobile operator 104 (see step 11 in FIG. 2). Finally, the mobile device 106 uses the decrypted broadcast key KB to decrypt the encrypted multicast/broadcast information (see step 12 in FIG. 2).

Following are some additional features, advantages and uses of the present solution:

(1) A broadcast key distribution problem was solved herein in a way that the existing GSM/UMTS security infrastructure can be used. In addition, the present solution is relatively easy for a skilled person in the art to implement and requires only a few additions to the existing security functionality in the mobile network and mobile devices. In contrast, the current MBMS security standard allows two different key management implementations; one UICC based and one mobile device based. The mobile device based solution is only secure if a particular common group key can be protected within the mobile device. Hence, the mobile device based solution does not work for a mobile device that has a valid UICC but has “hacked”, i.e. illegally modified the mobile device MEMS software. And, the UICC based solution only works when a new functionality is added to the existing smart cards. Hence, this is only an option for new UICCs and not for the existing large set of legacy cards such as SIM cards. The present solution does not have these security or deployment restrictions so it can work with old legacy cards.

(2) The present solution uses a content encryption key KE that is protected with individual keys for each mobile device. Hence, there is no common secret that needs to be spread to a large number of mobile devices which compromises the security of the system. Furthermore, the data (random nonce value Nᵢ) received from the broadcast service provider which is used to derive the content encryption key KE does not need any confidentiality protection.

(3) The present solution does not allow the mobile device to derive the content encryption key. KE until after it actually starts to receive the encrypted broadcasted content. Because, the mobile device needs the nonce values Ni which is sent to it along with the encrypted broadcasted contents before it can derive KE. Hence, it is difficult for a “hacked” mobile device to redistribute the content encryption key KE to other mobile devices and in this way circumvent the broadcast security protection.

(4) It should be appreciated that each of the components described herein like the mobile device and smart card etc. has a processor/computer/logic incorporated therein that can perform various actions in accordance with the present solution by using specialized circuits or circuitry (e.g., discrete logic gates interconnected to perform a specialized function), program instructions, or a combination of both.

(5) In an alternative embodiment, it is possible that the mobile operator 104 (instead of the service provider 102) can choose the session identification ID and the random nonce values N and encrypt the content. And, that the content is encrypted just before it is broadcasted.

Although two embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the scope of the invention as set forth and defined by the following claims.

1. In a multicast/broadcast network including a broadcast service provider, a mobile operator and a mobile device/smart card, wherein said broadcast service provider: (1) encrypts broadcast/multicast information based on a broadcast key (KB) to produce encrypted broadcast/multicast information; (2) generates a random nonce value (N) corresponding to the broadcast key (KB); (3) transmits the broadcast key (KB), a session identification (ID) and the random nonce value (N) to said mobile operator; and (4) transmits the encrypted broadcast/multicast information, the session identification (ID) and the random nonce value (N) to the mobile device/smart card, a method for protecting the broadcast/multicast information comprising the steps of:
encrypting, at said mobile operator, the broadcast key (KB) with a shared key (KE) to produce an encrypted broadcast key (KB′);
encrypting, at said mobile operator, a random challenge value (RAND) with the random nonce value (N) to produce an encrypted random challenge value (RAND′); and
transmitting, to said mobile device/smart card, the encrypted broadcast key (KB′), the encrypted random challenge value (RAND′), the session identification (ID) and if provided an authentication token (AUTN).

2. The method of claim 1, wherein said mobile device/smart card performs the following steps:
storing the encrypted broadcast key (KB′), the encrypted random challenge value (RAND′), the session identification (ID) and if provided the authentication token (AUTN);
upon receiving the encrypted broadcast/multicast information, the session identification (ID) and the random nonce value (N) from said broadcast service provider:
decrypting the encrypted random challenge value (RAND′) using the random nonce value (N) to obtain the random challenge value (RAND);
determining the shared key (KE) using the random challenge value (RAND) and if provided the authentication token (AUTN);
decrypting the encrypted broadcast key (KB′) using the shared key (KE) to obtain the broadcast key (KB); and
decrypting the encrypted broadcast/multicast information using the broadcast key (KB) to obtain the broadcast/multicast information.

3. The method of claim 1, wherein said mobile operator uses a data channel such as a SMS channel or a MMS channel to transmit the encrypted broadcast key (KB′), the encrypted random challenge value (RAND′), the session identification (ID) and if provided the authentication token (AUTN) to said mobile device/smart card.

4. The method of claim 1, wherein when said mobile operator and said mobile device/smart card utilize GSM then the shared key (KE) is related to a GSM encryption key (Kc).

5. The method of claim 4, wherein a response variable RES is also used in generating the shared key (KE).

6. The method of claim 1, wherein when said mobile operator and said mobile device/smart card utilize UMTS then the shared key (KE) is related to an UMTS encryption/integrity key (CKIK) and the authentication token (AUTN) is needed.

7. The method of claim 6, wherein a response variable SRES is also used in generating the shared key (KE).

8. The method of claim 1, wherein said broadcast/multicast information is mobile TV or multimedia.

9. The method of claim 1, wherein the mobile operator chooses the session identification (ID) and the random nonce values (N) and encrypts the content.

10. In a multicast/broadcast network including a broadcast service provider, a mobile operator and a mobile device/smart card, wherein said broadcast service provider: (1) encrypts broadcast/multicast information based on a broadcast key (KB) to produce encrypted broadcast/multicast information; (2) generates a random nonce value (N) corresponding to the broadcast key (KB); (3) transmits the broadcast key (KB), a session identification (ID) and the random nonce value (N) to said mobile operator; and (4) transmits the encrypted broadcast/multicast information, the session identification (ID) and the random nonce value (N) to the mobile device/smart card, a method for protecting the broadcast/multicast information comprising the steps of:
receiving, at said mobile device/smart card from said mobile operator, an encrypted broadcast key (KB′), an encrypted random challenge value (RAND′), the session identification (ID) and if provided an authentication token (AUTN);
receiving, at said mobile device/smart card from said broadcast service provider, the encrypted broadcast/multicast information, the session identification (ID) and the random nonce value (N);
decrypting, at said mobile device/smart card, the encrypted random challenge value (RAND′) using the random nonce value (N) to obtain the random challenge value (RAND);
determining, at said mobile device/smart card, a shared key (KE) using the random challenge value (RAND) and if provided the authentication token (AUTN);
decrypting, at said mobile device/smart card, the encrypted broadcast key (KB′) using the shared key (KE) to obtain the broadcast key (KB); and
decrypting, at said mobile device/smart card, the encrypted broadcast/multicast information using the broadcast key (KB) to obtain the broadcast/multicast information.

11. The method of claim 10, wherein said mobile operator performs the following steps prior to sending said mobile device/smart card the encrypted broadcast key (KB′), the encrypted random challenge value (RAND′), the session identification (ID), and if provided the authentication token (AUTN):
encrypting the broadcast key (KB) with a shared key (KE) to produce the encrypted broadcast key (KB′); and
encrypting a random challenge value (RAND) with the random nonce value (N) to produce the encrypted random challenge value (RAND′).

12. The method of claim 10, wherein said mobile operator uses a data channel such as a SMS channel or a MMS channel to transmit the encrypted broadcast key (KB′), the encrypted random challenge value (RAND′), the session identification (ID) and if provided the authentication token (AUTN) to said mobile device/smart card.

13. The method of claim 10, wherein when said mobile operator and said mobile device/smart card utilize GSM then the shared key (KE) is related to a GSM encryption key (Kc).

14. The method of claim 13, wherein a response variable RES is also used in generating the shared key (KE).

15. The method of claim 10, wherein when said mobile operator and said mobile device/smart card utilize UMTS then the shared key (KE) is related to a UMTS encryption/integrity key (CK,IK) and the authentication token (AUTN) is needed.

16. The method of claim 15, wherein a response variable SRES is also used in generating the shared key (KE).

17. The method of claim 10, wherein said broadcast/multicast information is mobile TV or multimedia.

18. The method of claim 10, wherein the mobile operator chooses the session identification (ID) and the random nonce values (N) and encrypts the content.

19. In a multicast/broadcast network including a broadcast service provider, a mobile operator and a mobile device/smart card, wherein said broadcast service provider: (1) encrypts broadcast/multicast information based on a broadcast key (KB) to produce encrypted broadcast/multicast information; (2) generates a random nonce value (N) corresponding to the broadcast key (KB); (3) transmits the broadcast key (KB), a session identification (ID) and the random nonce value (N) to said mobile operator; and (4) transmits the encrypted broadcast/multicast information, the session identification (ID) and the random nonce value (N) to the mobile device/smart card, said mobile device/smart card comprising logic that decrypts the encrypted broadcast/multicast information as follows:
logic that receives, from said mobile operator, an encrypted broadcast key (KB′), an encrypted random challenge value (RAND′), the session identification (ID) and if provided an authentication token (AUTN);
logic that receives, from said broadcast service provider, the encrypted broadcast/multicast information, the session identification (ID) and the random nonce value (N);
logic that decrypts the encrypted random challenge value (RAND′) using the random nonce value (N) to obtain a random challenge value (RAND);
logic that determines a shared key (KE) using the random challenge value (RAND) and if provided the authentication token (AUTN);
logic that decrypts the encrypted broadcast key (KB′) using the shared key (KE) to obtain the broadcast key (KB); and
logic that decrypts the encrypted broadcast/multicast information using the broadcast key (KB) to obtain the broadcast/multicast information.

20. The mobile device/smart card of claim 19, wherein said mobile operator comprising logic that performs the following steps prior to sending the mobile device/smart card the encrypted broadcast key (KB′), the encrypted random challenge value (RAND′), the session identification (ID) and if provided the authentication token (AUTN):
logic that encrypts the broadcast key (KB) with a shared key (KE) to produce the encrypted broadcast key (KB′); and
logic that encrypts a random challenge value (RAND) with the random nonce value (N) to produce the encrypted random challenge value (RAND′).

21. The mobile device/smart card of claim 19, wherein said broadcast/multicast information is mobile TV or multimedia.

22. The mobile device/smart card of claim 19, wherein when said mobile device/smart utilizes GSM then the shared key (KE) is related to a GSM encryption key (Kc).

23. The mobile device/smart card of claim 22, wherein a response variable RES is also used in generating the shared key (KE).

24. The mobile device/smart card of claim 19, wherein when said mobile device/smart utilizes UMTS then the shared key (KE) is related to a UMTS encryption/integrity key (CKIK) and the UMTS authentication token (AUTN) is needed.

25. The mobile device/smart card of claim 24, wherein a response variable SRES is also used in generating the shared key (KE).
